(19) United States
(12) Patent Application Publication
(10) Pub. No.: US 2016/0061312 A1
(43) Pub. Date: Mar. 3, 2016

(54) TRANSMISSION SHIPPING PLUG AND METHOD OF ASSEMBLY

(71) Applicant: FORD GLOBAL TECHNOLOGIES, LLC, Dearborn, MI (US)

(72) Inventors: Daniel ALDRICH, Stockbridge, MI (US); Hassan A. DARWISH, Dearborn Heights, MI (US); Mahindra Dev IMADABATHUNI, Novi, MI (US); Michael FREY, Livonia, MI (US); Michelle E. POPLE, Eaton Rapids, MI (US)

(21) Appl. No.: 14/472,509

(22) Filed: Aug. 29, 2014

(51) Int. Cl. F16H 57/02; B23P 19/04; F16L 55/11

(52) U.S. Cl. CPC F16H 57/02; F16L 55/11; B23P 19/04

(57) ABSTRACT

A shipping plug for a transmission port includes a ring having an inner wall defining a cavity and an outer wall having an annular sealing rib that is engageable with the port. A membrane spans an inner circumference of the inner wall to seal the cavity. The plug is pierceable and has a first condition where the membrane is intact and a second condition where the membrane is torn.

### TECHNICAL FIELD

The present disclosure relates to transmission shipping plugs that prevent oil from leaking out of transmission ports during shipment and assembly. The present disclosure also relates to a method for assembling a cooler line on a transmission.

### BACKGROUND

Automotive vehicles include a transmission. The transmissions may be assembled in a transmission assembly plant and shipped to another plant for final assembly in the vehicle. The transmission may be tested at the transmission assembly plant prior to shipment. Residual oil may be left within the transmission housing after testing. This residual oil may leak out of ports defined in the transmission housing during shipment and vehicle assembly. The leaking of residual oil may create pools of oil in the shipping container and on the assembly plant floor. The pools of oil must be cleaned up, which increases cost and reduces efficiencies.

One prior art solution includes a dual function cooler line fitting that function as both a fitting and a plug. The dual function fitting includes an outer metal ring and an inner rubber portion. The rubber portion includes a pierceable portion, that when intact, plugs the port. The metal ring is press fit into the port. The press fitting requires the outer surface of the metal ring to be smooth to create a tight fit and prevent transmission oil from leaking during operation of the vehicle. The cooler line punctures the rubber portion when installed. The rubber portion forms an oil tight seal between the line and the dual function fitting to prevent transmission oil from leaking during operation of the vehicle. The dual function fitting requires tight manufacturing tolerances because the fitting forms the seal between port and the cooler line. The tight manufacturing tolerances increase the cost of the part dual function part. The outer metal ring and the inner rubber portion of the fitting further increases manufacturing complexity and cost.

### SUMMARY

In one embodiment, a shipping plug for a port defined in a transmission includes a ring having an inner wall defining a cavity and an outer wall having an annular sealing rib that is engageable with the port. A membrane spans an inner circumference of the inner wall to seal the cavity.

In another embodiment, a transmission includes a housing defining a port therein and a shipping plug disposed within the port. The plug includes a ring having an inner wall defining an inner cavity and an outer wall having an annular sealing rib engaging with the port. A membrane spans an inner circumference of the inner wall to seal the cavity when in a first condition to prevent oil from leaking out of the port.

In yet another embodiment, a method is disclosed for assembling a cooler line on a transmission. A port is formed into the transmission. A shipping plug is installed into the port. The shipping plug includes a ring having an inner wall defining a cavity, an outer wall having an annular sealing rib and a membrane spanning the cavity. The annular sealing rib engages with an inner surface of the port to seal the port.

### BRIEF DESCRIPTION OF THE DRAWINGS

FIG. 1 is a perspective view of a portion of a transmission for a motor vehicle according to one embodiment of this disclosure.

FIG. 2 is a side cross-sectional view of the transmission of FIG. 1 illustrating the supply port.

FIG. 3 is a front perspective view of a shipping plug according to one embodiment of this disclosure.

FIG. 4 is a rear perspective view of the shipping plug according to one embodiment of this disclosure.

FIG. 5 is a side view of the shipping plug according to one embodiment of this disclosure.

FIG. 6 is a side cross-sectional view of the shipping plug according to one embodiment of this disclosure.

FIG. 7 is a prospective cross-sectional view of the transmission shown in FIG. 1 illustrating the shipping plug received within the return port.

FIG. 8 is a side cross-sectional view of the transmission shown in FIG. 7 illustrating a cooler line received within the port and the shipping plug.

FIG. 9 is a flowchart illustrating one example of a method of assembling a transmission.

### DETAILED DESCRIPTION

The illustrated embodiments are disclosed with reference to the drawings. However, it is to be understood that the disclosed embodiments are intended to be merely examples that may be embodied in various and alternative forms. The figures are not necessarily to scale and some features may be exaggerated or minimized to show details of particular components. The specific structural and functional details disclosed are not to be interpreted as limiting, but as a representative basis for teaching one skilled in the art how to practice the disclosed concepts.

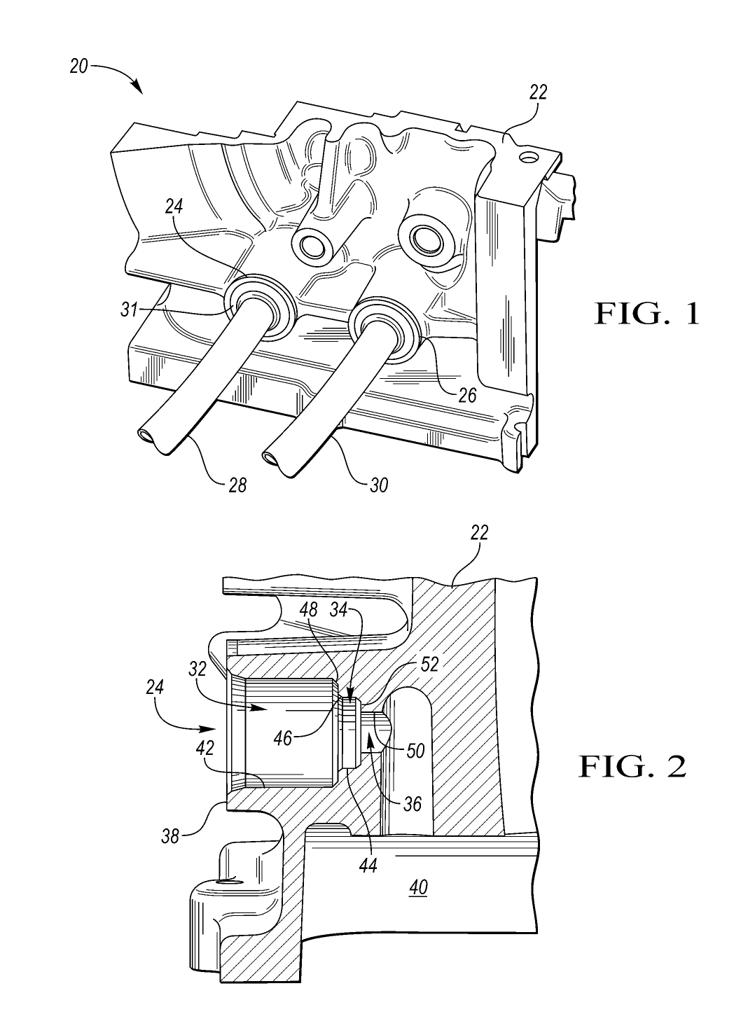

Referring to FIG. 1, a portion of a transmission 20 is illustrated. The transmission 20 includes a transmission housing 22 that defines a supply port 24 and a return port 26. The supply port 24 is coupled to a supply cooler line or supply tube 28. The supply port 24 connects the supply cooler line 28 to the interior of the transmission 20 and allows oil to flow from the cooler line 28 into the interior of the transmission. The return port 26 is coupled to a return cooler line or return tube 30. The return port 26 connects the return cooler line 30 to the interior of the transmission 20 and allows oil to exit the interior of the transmission. The cooler lines 28, 30 may be coupled to the transmission via a line fitting 31. For example, the line fitting may include a wedding band seal and a backing ring. Alternatively, the fitting 31 may be a manifold block including O-rings. The cooler lines 28, 30 are connected to a transmission cooling system that circulates oil through the transmission to regulate the temperature of the transmission 20 when the temperature of the transmission is above a desired operating temperature.

Referring to FIG. 2, the supply port 24 may include a main bore 32 having a first diameter, an intermediate bore 34 having a second diameter and a tip bore 36 having a third diameter. In the illustrated embodiment, the first diameter is larger than the second diameter and the second diameter is larger than the third diameter. The main bore 32 is located nearest to the exterior surface 38 of the transmission housing 22 and defines an opening into the housing 22. The tip bore 36 is farthest from the exterior surface 38 of the transmission housing 22 and defines an opening into the interior 40 of the transmission 20. The intermediate bore 34 is disposed between the main bore 32 and the tip bore 36. The main bore 32 includes a first cylindrical surface 42 and the intermediate bore 34 includes a second cylindrical surface 44. A first shoulder 46 interconnects the first and second surfaces 42, 44. The shoulder 46 may include a chamfered edge 48 where the shoulder 46 connects to the first surface 42. The tip bore 36 includes a third cylindrical surface 50. A second shoulder 52 interconnects the second and third surfaces 44, 50. The return port 26 may be structurally similar to the supply port 24.

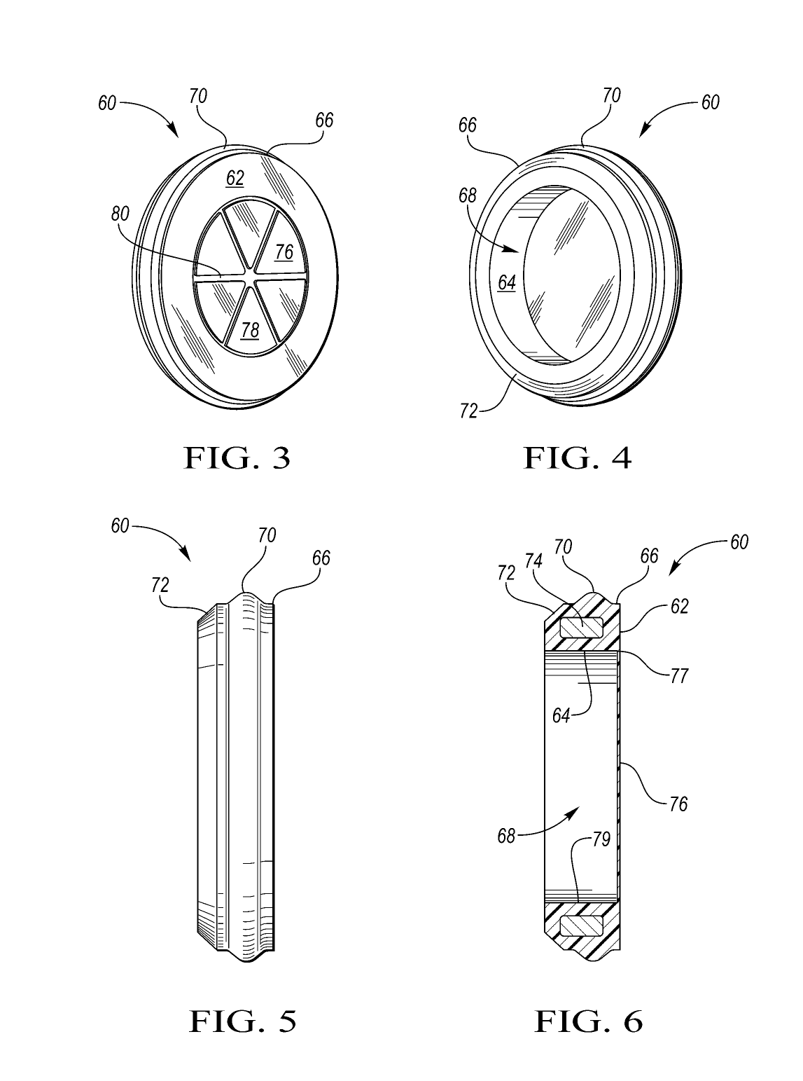

Referring to FIGS. 3 through 6, a shipping plug 60 is illustrated. A shipping plug 60 may be received within one or both of the ports 24, 26. The shipping plug 60 prevents oil disposed within the interior 40 of the transmission 20 from leaking out of the ports during shipment and at any time prior to final assembly of the cooler lines. The shipping plug 60 includes a ring 62 having an outer wall 66 and an inner wall 64. The inner and outer walls 64, 66 are concentric with each other. The inner wall 64 defines a cavity 68. The ring 62 also includes an annular sealing rib 70 extending radially outward from the outer wall 66. The annular sealing rib 70 engages the port and provides an oil tight seal between the port and the plug. The ring 62 may also include a chamfered edge 72 defined in one end of the outer wall 66. The ring 62 may be made out of plastic or rubber, such as an injection molded polymer. The plug 60 may include an annular insert 74 to increase rigidity and strength of the ring 62. The annular insert 74 is disposed between the inner wall 64 and the outer wall 66 and may be concentric with the ring 62. The annular insert 74 may be made of plastic, hard rubber, metal or other suitable material. Some designs do not include the insert 74.

The plug 60 also includes a membrane 76 connected along a circumference of the inner wall 64 and spanning over the cavity 68. The membrane 76 may be connected at an end 77 of the inner wall 64 or may be connected at an intermediate portion 79 of the inner wall 64. In some designs, the membrane 76 may be disposed on a side of the ring 62 that is opposite the chamfered edge 72. The membrane 76 is a relatively thin material and may have a thickness between 0.2 to 0.5 millimeters (mm). For example, the membrane may be an injection molded polymer. The membrane 76 may be integrally formed with the ring 62 and may be made of the same material. Unitary construction shipping plugs may reduce costs compared to non-unitary construction shipping plugs. The membrane 76 may be in a first condition with the membrane being intact and may be in a second condition with the membrane being torn. FIGS. 3 to 6 illustrate the membrane 76 in the first condition. In the first condition, the membrane 76 seals the cavity 68 and prevents any oil or other fluid from leaking out of the transmission 20. The membrane 76 may include main portions 78 and at least one tear portion 80 that is thinner than the main portions 78. The at least one tear portion 80 may be between 0.1 to 0.3 mm thick. The thinner tear portion 80 is designed to rip when an object (such as a cooler line) is pressed against the membrane 76 with sufficient force. The membrane 76 may include a single tear portion disposed between a pair of half-moon shaped main portions 78. Alternatively, as shown in FIG. 3, the membrane may include a plurality of main portions 78 separated by a plurality of tear portions 80. The tear portions 80 may be formed during the injection molding the plug 60 or may be formed into the membrane 76 in a secondary operation after the plug 60 is formed.

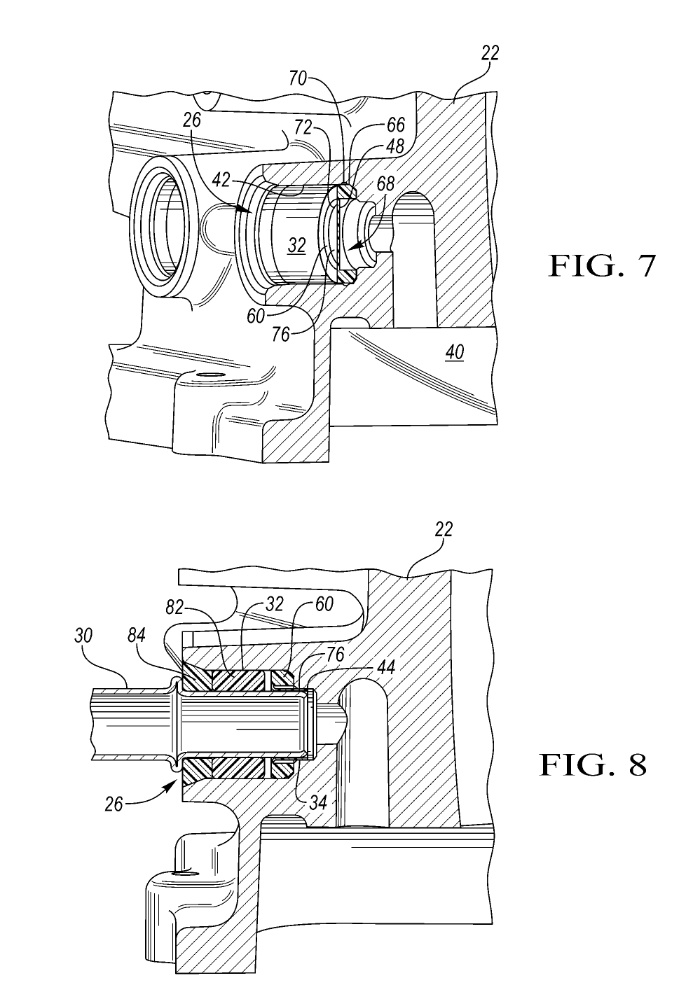

Referring to FIG. 7, the plug 60 is disposed within the main bore 32 of the return port 26 with the outer wall 66 disposed against the first surface 42. The chamfered edge 72 of the shipping plug 60 may be disposed against the chamfered edge 48 of the return port 26. The annular sealing rib 70 is engaged with the first surface 42 creating an oil tight seal between the port 26 and the plug 60. The diameter of the annular sealing rib 70 may be slightly larger than the diameter of the main bore 32. When installed, the annular sealing rib 70 is compressed by the first surface 42 creating a seal between the plug 60 and the port 26. The plug 60 is arranged within the port 26 with the membrane 76 facing the port opening and with the cavity 68 facing the interior 40 of the transmission 20. Alternatively, the plug 60 may be arranged within the port 26 with the membrane 76 facing the interior 40 of the transmission 20. In FIG. 7, the plug 60 shown in the first condition, with the membrane 76 sealing the cavity 68. In this condition, the plug 60 prevents oil from leaking out of the transmission.

Referring to FIG. 8, the shipping plug 60 is pierceable and is designed to be left in the transmission 20 after final assembly of the transmission. The shipping plug 60 is shown in a second condition where the membrane 76 is torn. A plug that remains in place is advantageous over a plug that must be removed, because it eliminates a manufacturing step and eliminates the possibility of oil leaking out of the transmission between removal of the plug and installation of additional transmission components.

After the plug 60 is installed, the plug remains in the first condition until the installation of an additional transmission component pierces the membrane 76. For example, the transmission 20 may include a return cooler line 30 that is received within the return port 26. A distal end of the return cooler line 30 pierces the membrane 76 when the line 30 is installed into the transmission 20. The shipping plug 60 switches from the first condition to the second condition when the membrane 76 is torn by the line 30. The line 30 is received within the port 26 with a portion of the line 30 extending through the cavity 68 of the plug 60. The shipping plug 60 is configured so that a portion of the membrane 76 extends from the main bore 32 to the intermediate bore 34 when the cooler line 30 is installed on the transmission 20. The membrane 76 is compressed between an outer surface of the line 30 and the second surface 44 of the intermediate bore 34 to trap the membrane 76 and prevent any pieces of the membrane 76 from entering into the transmission 20 and causing damage. The transmission 20 may include a plurality of ports that each include a shipping plug. For example, the transmission may further include a supply port 24 that receives the supply cooler line 28. The supply cooler line 28 may pierce a corresponding plug and may be received within the supply port 24 similar to the return line 30.

The cooler lines 28, 30 may be coupled to the transmission by any conventional methods known in the art. For example, the return line 30 may be secured to the transmission via a wedding band seal 82 and a backing ring 84. The wedding band seal 82 is be disposed between an outside surface of the line 30 and the first surface 42 of the port 26. The backing ring 84 is disposed between an outside surface of the line 30 and the inside surface 42 of the port 26. The backing ring 84 is disposed in the entrance region of the port 26 and the wedding band seal 82 is disposed between the backing ring 84 and the plug 60. The backing ring 84 and the wedding band seal 82 cooperate to seal and secure the line 30 to the transmission 20. Alternatively, the return line 30 may be connected to a manifold block. The manifold includes a portion that is inserted into the port. The portion defines at least one groove for receiving an O-ring. The O-ring forms an oil tight seal to prevent oil from leaking out of the port. The manifold block includes a hollow center for receiving the cooler line and providing a fluid opening into the port. The manifold block embodiment allows the cooler line to be connected to the transmission at a 90 degree angle to provide improved packing space.

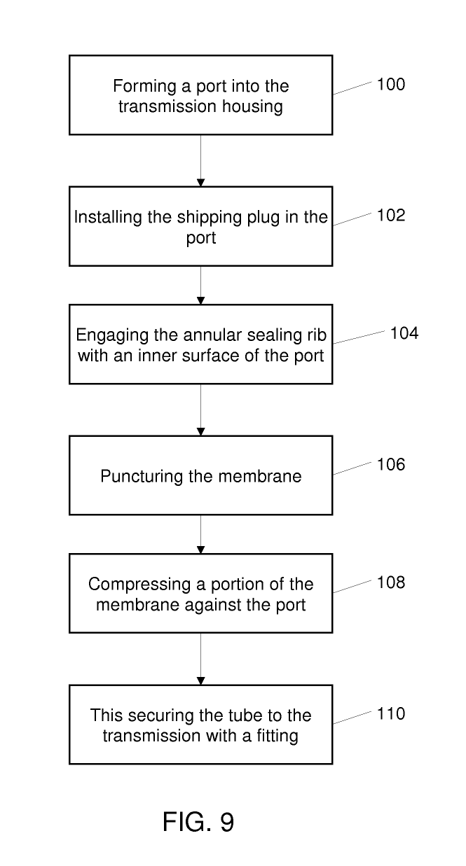

FIG. 9 is a flowchart illustrating a method of assembling a cooler line on a transmission. References to the component parts in the following description of the method are illustrated in FIGS. 1 through 8. At step 100, at least one port is provided in the transmission housing 22. The port may be a supply port 24 configured to receive a supply cooler line 28. Alternatively, the port may be a return port 26 configured to receive a return cooler line 30. At step 102, the shipping plug 60 is installed into the port 26. At step 104, the annular sealing rib 70 engages an inner surface of the port 26 when the shipping plug 60 is installed creating an oil tight seal between the port 26 and the plug 60. The shipping plug 60 prevents oil from leaking out of the transmission 20 until the transmission cooler line 30 is installed on the transmission 20. At step 106, a distal end of the line or tube 30 punctures the membrane 76 when the line 30 is received within the port 26. The line 30 is received within the cavity 68 of the plug when installed. The line 30 causes the torn membrane 76 to extend through the cavity 68 of plug 60 when the line 30 is received by the plug 60. At least a portion of the torn membrane 76 may extend past an end of the plug 60. At step 108, the line 30 compresses a portion of the membrane 76 against an inside surface of the port 26 to prevent the membrane 76 from entering into an internal cavity of the transmission and causing damage. For example, the portion of the membrane that extends past the plug 60 may be compressed between the second surface 44 and the line 30. At step 110, the line 30 is secured to the transmission with a fitting 31 disposed between the line and the port. For example, a wedding band seal may be disposed within the port between the outside surface of the line and the first surface 42.

The embodiments described above are specific examples that do not describe all possible forms of the disclosure. The features of the illustrated embodiments may be combined to form further embodiments of the disclosed concepts. The words used in the specification are words of description rather than limitation. The scope of the following claims is broader than the specifically disclosed embodiments and also includes modifications of the illustrated embodiments.

What is claimed is:

1. A shipping plug, for a port defined in a transmission, comprising:
a ring including an inner wall defining a cavity and an outer wall having an annular sealing rib that is engageable with the port; and
a membrane spanning an inner circumference of the inner wall to seal the cavity.

2. The shipping plug of claim 1 wherein the annular sealing rib extends radially outward from the outer wall.

3. The shipping plug of claim 1 wherein the ring further comprises an annular insert disposed within the ring.

4. The shipping plug of claim 1 wherein the outer wall further comprises a chamfered edge.

5. The shipping plug of claim 1 wherein the membrane includes a main portion having a first thickness and a tear portion having a second thickness that is thinner than the first thickness.

6. The shipping plug of claim 1 wherein the membrane includes at least one tear portion defining a plurality of fingers, the fingers being connect together along the at least tear portion in a first condition and being separated from each other in a second condition when the membrane is punctured.

7. The shipping plug of claim 1 wherein the ring and the membrane are integrally formed and are made of an injection molded polymer.

8. A transmission comprising:
a housing defining a port therein; and
a shipping plug disposed within the port, the plug including a ring having an inner wall defining an inner cavity and an outer wall having an annular sealing rib engaging with the port, and a membrane spanning an inner circumference of the inner wall to seal the cavity when in a first condition to prevent oil from leaking out of the port.

9. The transmission of claim 8 wherein the ring and the membrane are integrally molded.

10. The transmission of claim 8 wherein the annular sealing rib extends radially outward from the outer wall.

11. The transmission of claim 8 wherein the port further comprises a first bore having a first diameter, a second bore have a second diameter that is smaller than the first diameter, and a shoulder defined between the first and second bores, the shoulder including a chamfered edge between the shoulder and the first bore, and wherein the outer wall of the shipping plug includes a chamfered edge that is disposed against the chamfered edge of the shoulder.

12. The transmission of claim 11 wherein the port further comprises a third bore adjacent to the second bore, and wherein, in a second condition, the transmission further comprises a tube disposed in the port and extending through the membrane such that the membrane is torn and extends from the second bore to the third bore.

13. The transmission of claim 8 wherein the ring further comprises an annular insert disposed within the ring.

14. The transmission of claim 8 wherein, in a second condition, the transmission further comprises a tube disposed in the port and in the cavity such that an end of the tube extends through the membrane, which is torn in the second condition.

15. The transmission of claim 14 wherein the membrane is compressed between the tube and the port to prevent the membrane from entering into an internal cavity of the transmission and causing damage.

16. The transmission of claim 14 further comprising a tube fitting disposed between the tube and the port to seal and secure the tube to the transmission.

17. A method, of assembling a cooler line on a transmission, comprising:
forming a port into the transmission;
installing a shipping plug into the port, the plug including a ring having an inner wall defining a cavity, an outer wall having an annular sealing rib and a membrane spanning the cavity; and
engaging the annular sealing rib with an inner surface of the port to seal the port.

18. The method of claim 17 further comprising the step of:
puncturing the membrane with a tube received within the port.

19. The method of claim 18 further comprising the step of:
compressing the punctured membrane between the tube and the port to prevent the membrane from entering into an internal cavity of the transmission and causing damage.

20. The method of claim 19 further comprising the step of:
securing the tube to the transmission with a fitting disposed between the tube and the port and disposed between the plug and an entrance of the port.
